(19) United States
(12) Patent Application Publication
(10) Pub. No.: US 2003/0087569 A1
(43) Pub. Date: May 8, 2003

(54) Ultraviolet resistant laminate and method of manufacture

(76) Inventor: Philip Edward Harris, High Point, NC (US)

Correspondence Address: Finnegan, Henderson, Farabow,, Garrett & Dunner, L.L.P., 1300 I Street, N.W., Washington, DC, 20005-3315, US

(21) Appl. No.: 10/191,392

(22) Filed: Jul. 1, 2002

Related U.S. Application Data
(60) Provisional application No. 60/301,441, filed on Jun. 29, 2001.

(51) Int. Cl. B32B 5/02; B32B 27/04; B32B 27/12

(52) U.S. Cl. 442/131; 442/149; 156/325

(57) ABSTRACT

An ultraviolet-resistant laminate includes a first substrate, a second substrate, and adhesive including an uncompounded amorphous polyolefin polymer. The adhesive secures the first substrate to the second substrate so as to form a bond. The resulting laminate is resistant to ultraviolet exposure. A method of forming a laminate includes providing a first substrate, providing a second substrate, applying an adhesive including an uncompounded amorphous polyolefin polymer to at least one of the first substrate and the second substrate, and securing the first substrate to the second substrate with the adhesive so as to form a bond. The laminate produced is resistant to ultraviolet exposure. The laminate may be used in outdoor products, such as awnings, umbrellas, table cloths, tarpaulins, transportation packaging, signs, banners, coverings for outdoor furniture, and coverings for vehicles.

This application claims benefit of priority of U.S. Provisional Application No. 60/301,441, filed Jun. 29, 2001, the entire contents of which are incorporated herein by reference.

### BACKGROUND OF THE INVENTION

1. Field of the Invention

The present invention relates to a laminate and, more particularly, to a laminate that is resistant to ultraviolet light. The laminate may be used in a variety of applications including, for example, awnings, tarpaulins, transportation packaging, banners, and coverings for outdoor items, including outdoor furniture and vehicles, such as, automobiles, boats, and aircraft.

2. Description of the Related Art

Conventional ultraviolet-resistant products have been made using compounded ultraviolet-resistant adhesives based on amorphous polypropylene or styrene-ethylene/butylene-styrene block copolymers. Many compounded adhesives are formulated using tackifier resins such as rosin esters, aromatic hydrocarbon resins, polyterpene resins, terpene phenolic resins, and/or aromatic/aliphatic modified hydrocarbon resins. These tackifiers typically contain some degree of unsaturation in their molecular structure, which leaves them susceptible to oxidation or attack by ultraviolet light.

In addition, other additives, such as process oils, waxes, plasticizers, and/or other materials may be added to the adhesive to modify its properties, such as, for example, viscosity, open time, set time, flexibility, specific adhesion, pressure sensitivity, and/or other specific desired properties of the adhesive. These other additives may also affect the resistance of the resulting adhesive to oxidation or degradation by ultraviolet light.

Still further, stabilizers, such as hindered phenols (as primary antioxidants), phosphites/phosphonites (as synergists), thiosynergists, hindered amine light stabilizers (HALS), benzotriazoles, and/or benzophenones (as ultraviolet absorbers), and/or other compounds may also be added to the adhesive formulations to obtain thermal and/or light stability of the adhesives.

Conventional ultraviolet-resistant products have been produced by bonding a substrate, such as, for example, a film or a fabric, to another substrate using compounded adhesives based on styrene-isoprene-styrene block copolymers. These adhesives have exhibited good bond strengths before exposure to ultraviolet light, but have not exhibited good resistance to ultraviolet light under laboratory test conditions.

A need exists for laminated products that are relatively inexpensive to produce, are resistant to degradation by ultraviolet light, and are durable to weathering in outdoor exposure conditions. There is also a need for a laminate and a process for manufacturing such a laminate that will yield bond strengths which are consistent, reproducible, and resistant to ultraviolet light.

### SUMMARY OF THE INVENTION

To overcome the drawbacks of the prior art and in accordance with the purpose of the invention, as embodied and broadly described herein, one aspect of the invention relates to a laminate comprising a first substrate, a second substrate, and adhesive comprising an uncompounded amorphous polyolefin polymer. The adhesive secures the first substrate to the second substrate so as to form a bond. The resulting laminate is resistant to ultraviolet exposure.

As used herein, “ultraviolet exposure” means the exposure to ultraviolet energy provided by the test method described below or its equivalent. Further, as used herein, “resistant to ultraviolet exposure” means that a bond of the laminate has a bond strength that remains stable after exposure to the test method described below or its equivalent.

Another aspect of the invention relates to a method of forming a laminate comprising providing a first substrate, providing a second substrate, applying an adhesive comprising an uncompounded amorphous polyolefin polymer to at least one of the first substrate and the second substrate, and securing the first substrate to the second substrate with the adhesive so as to form a bond. The resulting laminate is resistant to ultraviolet exposure.

As used herein, the term “providing” is used in a broad sense, and refers to, but is not limited to, making available for use, enabling usage, giving, supplying, obtaining, getting a hold of, acquiring, purchasing, selling, distributing, possessing, making ready for use, and/or placing in a position ready for use.

Additional advantages of the invention will be set forth in part in the description that follows. The advantages of the invention will be realized and attained by the elements and combinations particularly pointed out in the appended claims.

It is to be understood that both the foregoing general description and the following detailed description are exemplary and explanatory only and are not restrictive of the invention, as claimed.

### DETAILED DESCRIPTION OF EXEMPLARY EMBODIMENTS

Reference will now be made in detail to the exemplary embodiments of the invention. It should be understood that all embodiments discussed herein are exemplary regardless of whether they are referred to as “exemplary” embodiments.

The laminate according to the present invention comprises a first substrate, a second substrate, and adhesive comprising an uncompounded amorphous polyolefin polymer. The adhesive secures the first substrate to the second substrate so as to form a bond.

The first substrate and the second substrate may be chosen from fabrics, foams, films, and paper. Other materials may also be used. In one embodiment, the first substrate comprises a fabric and the second substrate comprises a film. In another embodiment, the first substrate comprises a nonwoven fabric and the second substrate comprises a heat-shrinkable film.

One or more of the substrates may be treated, such as, for example, surface treated, before being secured with the adhesive. In one embodiment, the second substrate is surface treated before being secured to the first substrate. The surface treatment may comprise at least one of calendaring, corona treatment, plasma treatment, ozone treatment, and flame treatment. Other treatments may also be used.

The adhesive may comprise at least one of a hot melt, a web, and a powder. Further, the adhesive may be applied to at least one of the first substrate and the second substrate using at least one of a spray applicator, a gravure coater, a screen print applicator, and a slot dye machine. Other application devices may also be used.

In one embodiment, the uncompounded amorphous polyolefin polymer comprises a butene-1 copolymer. Other polymers may also be used. The adhesive may have a glass transition temperature of −40° Celsius or greater. In one embodiment, the adhesive has a glass transition temperature of approximately −20° Celsius.

In an embodiment of the laminate, the adhesive is applied to at least one of the first substrate and the second substrate in an amount ranging from 1 to 50 g/m². In a further embodiment, the adhesive is applied to at least one of the first substrate and the second substrate in an amount ranging from 4 to 20 g/m².

The laminate according to the present invention is resistant to ultraviolet exposure. In one embodiment, after 500 hours of ultraviolet exposure the bond maintains at least 50% of a pre-exposure bond strength. In a further embodiment, after 500 hours of ultraviolet exposure the bond maintains at least 75% of a pre-exposure bond strength. In a still further embodiment, after 500 hours of ultraviolet exposure the bond maintains at least 90% of a pre-exposure bond strength.

Laminates according to the present invention can be formed using adhesives that provide bonds of different strengths. The bonds maintain their strength after ultraviolet exposure. In one embodiment, after 500 hours of ultraviolet exposure the bond has a strength of at least 100 g/25 mm. In another embodiment, after 500 hours of ultraviolet exposure the bond has a strength of at least 200 g/25 mm.

The laminate of the present invention may further comprise at least one additional substrate and adhesive securing the at least one additional substrate to at least one of the first substrate and the second substrate so as to form a bond.

The laminate according to the present invention may be used in a variety of applications. In one embodiment, an outdoor product may be constructed from the laminate of the present invention. As used herein, “outdoor product” means a product primarily used in an area that is exposed to direct or reflected ultraviolet light. The outdoor product may be chosen from awnings, umbrellas, table cloths, tarpaulins, transportation packaging, signs, banners, coverings for outdoor furniture, and coverings for vehicles. The coverings for outdoor furniture may include, for example, coverings for tables, chairs, lounges, and grills. The coverings for vehicles may include, for example, coverings for automobiles, boats, and aircraft. The coverings for vehicles may be covers intended for temporary use or structures that form a permanent part of the vehicle. The laminate may also be used in other outdoor products, as well as in products having little or no exposure to ultraviolet light.

A method of forming a laminate according to the present invention comprises providing a first substrate, providing a second substrate, applying an adhesive comprising an uncompounded amorphous polyolefin polymer to at least one of the first substrate and the second substrate, and securing the first substrate to the second substrate with the adhesive so as to form a bond. The laminate formed according to the method is resistant to ultraviolet exposure.

The adhesive may comprise at least one of a hot melt, a web, and a powder. Further, the adhesive may be applied using at least one of a spray applicator, a gravure coater, a screen print applicator, and a slot dye machine. Other application devices may also be used.

In one embodiment, the uncompounded amorphous polyolefin polymer comprises a butene-1 copolymer. Other polymers may also be used. The adhesive may have a glass transition temperature of −40° Celsius or greater. In one embodiment, the adhesive has a glass transition temperature of approximately −20° Celsius.

According to the method of the present invention, one or more of the substrates may be treated, such as, for example, surface treated, before being secured with the adhesive. In one embodiment, the second substrate is surface treated before being secured to the first substrate. The surface treatment may comprise at least one of calendaring, corona treatment, plasma treatment, ozone treatment, and flame treatment. Other treatments may also be used.

In one embodiment, the method may further comprise applying pressure to the first substrate and the second substrate after applying the adhesive to force the first substrate and the second substrate together.

In another embodiment, the method may further comprise finish treating the laminate. The finish treating may comprise heat treating, although other finish treating may also be used.

In a still further embodiment, the method may further comprise providing at least one additional substrate, applying adhesive to at least one of the first substrate and the second substrate, and securing the at least one additional substrate to the at least one of the first substrate and the second substrate with the adhesive so as to form a bond.

Laboratory tests were conducted on a set of conventional ultraviolet-resistant laminates made from a film substrate bonded to a fabric substrate. In the tests, each laminate was cut into six swatches, each having an area of approximately 7″×22″ (17.78 cm×55.88 cm). One of the swatches of each laminate was used to provide baseline (i.e., pre-exposure) data. The remaining five swatches of each laminate were placed in an Atlas Model 65/XW-WR WEATHER-OMETER testing device with the film side of the laminate facing the light source. Samples were clamped at their corners to a revolving cage within the WEATHER-OMETER.

The WEATHER-OMETER was configured using a xenon arc light source. The light source was run at 340 nm with a light monitor set at 0.32 W/m² irradiance. The light was run continuously for 500 hours at a humidity of 50-60%. The black panel was set at 68+/−5° C. The wet bulb setting was 42+/−2° C. and the dry bulb setting was 52+/−2° C. One swatch of each laminate was removed from the WEATHER-OMETER every 100 hours. At the end of 500 hours of exposure, all samples were tested for bond strength using INDA Standard Test Method 110.3.

Test results for several conventional ultraviolet-resistant laminates are presented below in Tables 1 and 2. Each laminate was made from the same fabric substrate and film substrate bonded with a different adhesive. The adhesives are identified as A-E. In the tables, the bond strengths (in units of g/25 mm) of the laminates are shown in the pre-exposed condition (0 hours) and after exposure to ultraviolet light in increments of 100 hours, up to 500 total hours of exposure. The bond strengths were measured in both the machine direction (MD) and the cross direction (XD) of the laminates. The machine direction results are shown in Table 1 and the cross direction results are shown in Table 2.

TABLE 1
MD Bond Strength (g/25 mm) of Conventional Laminates

| Hours | A¹ | B² | C³ | D³ | E³ |
|---|---|---|---|---|---|
| 0 | 826 | 173 | 786 | 631 | 795 |
| 100 | 30 | 201 | 109 | 9 | 57 |
| 200 | 29 | 55 | 46 | 16 | 22 |
| 300 | 43 | 22 | 24 | 9 | 20 |
| 400 | 73 | 19 | 15 | 3 | 24 |
| 500 | 46 | 34 | 12 | 0 | 22 |

¹Compounded styrene-isoprene-styrene (SIS) adhesive
²Compounded styrene-ethylene/butylene-styrene (SEBS) adhesive
³Compounded amorphous poly alpha olefin (APAO) adhesive

TABLE 2
XD Bond Strength (g/25 mm) of Conventional Laminates

| | | | | | |
|---|---|---|---|---|---|
| Hours | A¹ | B² | C³ | D³ | E³ |

| | | | | | |
|---|---|---|---|---|---|
| 0 | 502 | 241 | 809 | 394 | 434 |
| 100 | 39 | 248 | 71 | 9 | 64 |
| 200 | 27 | 51 | 27 | 15 | 38 |
| 300 | 35 | 0 | 36 | 6 | 28 |
| 400 | 44 | 17 | 10 | 0 | 21 |
| 500 | 37 | 40 | 7 | 0 | 19 |

¹Compounded styrene-isoprene-styrene (SIS) adhesive
²Compounded styrene-ethylene/butylene-styrene (SEBS) adhesive
³Compounded amorphous poly alpha olefin (APAO) adhesive

As shown in the tables, the conventional laminates did not exhibit good resistance to ultraviolet light. In all cases, the bond strength of the laminates exposed to ultraviolet light dropped to a fraction of the pre-exposure bond strength after 200 hours of ultraviolet exposure.

Two laminates according to the present invention were subjected to the test method described above. These laminates were made from the same fabric substrate and film substrate as the conventional laminates described above. Each laminate was formed using a different uncompounded amorphous poly alpha olefin adhesive.

As described above, each laminate was cut into six swatches. One of the swatches of each laminate was used to provide pre-exposure data and the remaining five swatches were placed in the WEATHER-OMETER testing device. One swatch of each laminate was removed from the testing device every 100 hours. At the end of 500 hours of exposure, all samples of the two laminates were tested for bond strength using INDA Standard Test Method 110.3.

The test results for the laminates are presented below in Tables 3 and 4. The adhesives used in the two laminates are identified as F and G, respectively. In the tables, the bond strengths (in units of g/25 mm) of the laminates are shown in the pre-exposed condition (0 hours) and after exposure to ultraviolet light in increments of 100 hours, up to 500 total hours of exposure. The bond strengths were measured in both the machine direction (MD) and the cross direction (XD) of the laminates. The machine direction results are shown in Table 3 and the cross direction results are shown in Table 4.

TABLE 3
MD Bond Strength (g/25 mm) of Laminates of Invention

| Hours | F¹ | G² |
|---|---|---|
| 0 | 53 | 227 |
| 100 | 18 | 262 |
| 200 | 46 | 194 |
| 300 | 59 | 165 |
| 400 | 0 | 185 |
| 500 | 49 | 205 |

¹Uncompounded amorphous poly alpha olefin (APAO) adhesive made by H. B. Fuller
²Uncompounded amorphous poly alpha olefin (APAO) adhesive made by Huntsman

TABLE 4
XD Bond Strength (g/25 mm) of Laminates of Invention

| Hours | F¹ | G² |
|---|---|---|
| 0 | 59 | 282 |
| 100 | 33 | 286 |
| 200 | 76 | 276 |
| 300 | 102 | 217 |
| 400 | 0 | 235 |
| 500 | 39 | 215 |

¹Uncompounded amorphous poly alpha olefin (APAO) adhesive made by H. B. Fuller
²Uncompounded amorphous poly alpha olefin (APAO) adhesive made by Huntsman

As shown in Tables 3 and 4, the laminates according to the present invention maintained good resistance to ultraviolet light even after 500 hours of exposure.

In addition to its favorable ultraviolet resistance characteristics, the laminate according to the present invention may be produced more economically than conventional laminates. For example, the laminate may be produced with the adhesive at a relatively low processing temperature. In one example, a laminate was produced with the adhesive at approximately 150° C. (300° F.), as compared to approximately 190° C. (375° F.) for conventional compounded adhesives.

Further, the adhesive used with the laminate of the present invention may have a pressure sensitive character without the addition of plasticizers, liquid tackifier resins, or process oils. Also, no additional ultraviolet absorbers, inhibitors, or other stabilizers are needed to prevent degradation of the polymer by ultraviolet light. Therefore, materials costs may be reduced. Further, none of these materials are present to degrade under ultraviolet exposure or leach out of the adhesive and damage paint or other surfaces covered by the laminate.

Further, because the adhesive used with the laminate of the present invention has a glass transition temperature of approximately −20° C., the laminate may have good low temperature performance without the adhesive becoming brittle.

An example of an ultraviolet-resistant laminate according to the present invention will now be described.

### EXAMPLE

A Du Pont 1.2 oz/yd² spunlaced polyester nonwoven fabric was laminated to a Crayex 0.007 inch thick polyethylene/ethylene vinyl acetate blend, corona treated, shrinkable film using an uncompounded amorphous poly alpha olefin polymer adhesive made by Huntsman Corporation. The film used had a known shrink rate using American Standard Test Method (ASTM) D1204-84 of 58% in the machine direction and 33% in the cross direction. The nonwoven fabric was laminated to the corona treated side of the film.

The adhesive was applied to the nonwoven fabric using a Nordson POROUS COAT slot dye machine at approximately 150° C. (300° F.) in a quantity of 6 g/m² in a random dot pattern to produce a discontinuous attachment of the nonwoven fabric to the film.

The nonwoven fabric with adhesive applied was joined to the film by passing the fabric and the film through a pair of rollers applying a pressure of 90 psi. The resulting laminate had bond strengths averaging above 200 g/25 mm in the machine direction and above 200 g/25 mm in the cross direction. When exposed to xenon arc ultraviolet light, the bond strengths of the laminate remained stable for at least 500 hours of exposure so that bond strengths after the exposure averaged above 150 g/25 mm in the machine direction and above 200 g/25 mm in the cross direction.

In one exemplary application, the laminate of the present invention comprising a nonwoven substrate and a film substrate may be placed over an object and heated to activate the film. When the film is heated, the laminate shrinks to fit the object and forms a closely fitting protective layer which does not rely on straps or other binders to secure it in place.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A laminate, comprising:
a first substrate;
a second substrate; and
adhesive comprising an uncompounded amorphous polyolefin polymer, the adhesive securing the first substrate to the second substrate so as to form a bond, wherein the laminate is resistant to ultraviolet exposure.

2. The laminate of claim 1, wherein after 500 hours of ultraviolet exposure the bond maintains at least 50% of a pre-exposure bond strength.

3. The laminate of claim 2, wherein after 500 hours of ultraviolet exposure the bond maintains at least 75% of a pre-exposure bond strength.

4. The laminate of claim 3, wherein after 500 hours of ultraviolet exposure the bond maintains at least 90% of a pre-exposure bond strength.

5. The laminate of claim 1, wherein after 500 hours of ultraviolet exposure the bond has a strength of at least 100 g/25 mm.

6. The laminate of claim 5, wherein after 500 hours of ultraviolet exposure the bond has a strength of at least 200 g/25 mm.

7. The laminate of claim 1, wherein the adhesive comprises at least one of a hot melt, a web, and a powder.

8. The laminate of claim 1, wherein the adhesive is applied to at least one of the first substrate and the second substrate using at least one of a spray applicator, a gravure coater, a screen print applicator, and a slot dye machine.

9. The laminate of claim 1, wherein the polymer comprises a butene-1 copolymer.

10. The laminate of claim 1, wherein the adhesive has a glass transition temperature of −40° Celsius or greater.

11. The laminate of claim 10, wherein the adhesive has a glass transition temperature of approximately −20° Celsius.

12. The laminate of claim 1, wherein the adhesive is applied to at least one of the first substrate and the second substrate in an amount ranging from 1 to 50 g/m².

13. The laminate of claim 12, wherein the adhesive is applied to at least one of the first substrate and the second substrate in an amount ranging from 4 to 20 g/m².

14. The laminate of claim 1, wherein the second substrate is surface treated before being secured to the first substrate.

15. The laminate of claim 14, wherein the surface treatment comprises at least one of calendaring, corona treatment, plasma treatment, ozone treatment, and flame treatment.

16. The laminate of claim 1, further comprising:
at least one additional substrate; and
adhesive securing the at least one additional substrate to at least one of the first substrate and the second substrate so as to form a bond.

17. The laminate of claim 1, wherein the first substrate and the second substrate are chosen from fabrics, foams, films, and paper.

18. The laminate of claim 17, wherein the first substrate comprises a fabric and the second substrate comprises a film.

19. The laminate of claim 18, wherein the first substrate comprises a nonwoven fabric and the second substrate comprises a heat-shrinkable film.

20. An outdoor product constructed from the laminate claimed in claim 1.

21. The outdoor product of claim 20, wherein the outdoor product is chosen from awnings, umbrellas, table cloths, tarpaulins, transportation packaging, signs, banners, coverings for outdoor furniture, and coverings for vehicles.

22. A method of forming a laminate, comprising:
providing a first substrate;
providing a second substrate;
applying an adhesive comprising an uncompounded amorphous polyolefin polymer to at least one of the first substrate and the second substrate; and
securing the first substrate to the second substrate with the adhesive so as to form a bond, wherein the laminate is resistant to ultraviolet exposure.

23. The method of claim 22, wherein after 500 hours of ultraviolet exposure the bond maintains at least 50% of a pre-exposure bond strength.

24. The method of claim 23, wherein after 500 hours of ultraviolet exposure the bond maintains at least 75% of a pre-exposure bond strength.

25. The method of claim 24, wherein after 500 hours of ultraviolet exposure the bond maintains at least 90% of a pre-exposure bond strength.

26. The method of claim 22, wherein after 500 hours of ultraviolet exposure the bond has a strength of at least 100 g/25 mm.

27. The method of claim 26, wherein after 500 hours of ultraviolet exposure the bond has a strength of at least 200 g/25 mm.

28. The method of claim 22, wherein the adhesive comprises at least one of a hot melt, a web, and a powder.

29. The method of claim 22, wherein the adhesive is applied using at least one of a spray applicator, a gravure coater, a screen print applicator, and a slot dye machine.

30. The method of claim 22, wherein the polymer comprises a butene-1 copolymer.

31. The method of claim 22, wherein the adhesive has a glass transition temperature of −40° Celsius or greater.

32. The method of claim 31, wherein the adhesive has a glass transition temperature of approximately −20° Celsius.

33. The method of claim 22, wherein the adhesive is applied in an amount ranging from 1 to 50 g/m².

34. The method of claim 33, wherein the adhesive is applied in an amount ranging from 4 to 20 g/m².

35. The method of claim 22, wherein the second substrate is surface treated before being secured to the first substrate.

36. The method of claim 35, wherein the surface treatment comprises at least one of calendaring, corona treatment, plasma treatment, ozone treatment, and flame treatment.

37. The method of claim 22, further comprising applying pressure to the first substrate and the second substrate after applying the adhesive to force the first substrate and the second substrate together.

38. The method of claim 22, further comprising finish treating the laminate.

39. The method of claim 38, wherein finish treating comprises heat treating.

40. The method of claim 22, further comprising:
providing at least one additional substrate;
applying adhesive to at least one of the first substrate and the second substrate; and
securing the at least one additional substrate to the at least one of the first substrate and the second substrate with the adhesive so as to form a bond.

41. The method of claim 22, wherein the first substrate and the second substrate are chosen from fabrics, foams, films, and paper.

42. The method of claim 41, wherein the first substrate comprises a fabric and the second substrate comprises a film.

43. The laminate of claim 42, wherein the first substrate comprises a nonwoven fabric and the second substrate comprises a heat-shrinkable film.

44. An outdoor product formed using the method claimed in claim 22.

45. The outdoor product of claim 44, wherein the outdoor product is chosen from awnings, umbrellas, table cloths, tarpaulins, transportation packaging, signs, banners, coverings for outdoor furniture, and coverings for vehicles.
